(19) United States
(12) Patent Application Publication
(10) Pub. No.: US 2006/0028349 A1
(43) Pub. Date: Feb. 9, 2006

(54) LED indicator set with radio signal transmitter

(76) Inventor: Richard Hsu, Ling Ya Dist. (TW)

Correspondence Address: LEONG C LEI, PMB # 1008, 1867 YGNACIO VALLEY ROAD, WALNUT CREEK, CA, 94598, US

(21) Appl. No.: 10/913,330

(22) Filed: Aug. 9, 2004

(51) Int. Cl. G08B 21/00; G09F 9/33

(52) U.S. Cl. 340/654; 340/815.45

(57) ABSTRACT

A light emission diode indicator set including a radio signal transmitter being adapted to a vehicle to synchronously transmit radio signals and emit light; the indicator set being further connected to an external warning indicator to receive radio signal to activate LED in the external warning indicator set.

### BACKGROUND OF THE INVENTION

(a) Technical Field of the Invention

The present invention is related to a light emitting diode indicator set with radio signal transmitter, and more particularly, to one that is adapted to a motor vehicle to transmit radio signals simultaneously with light emission.

(b) Description of the Prior Art

Additional to head lamps, a direction indicator set 1 including direction indicator lamp 10, reversing light lamp 11, rear indicator lamp 12 and braking indicator lamp 13 as illustrated in FIGS. 1 and 2 is generally provided to various locations of a motor vehicle.

As illustrated in FIG. 3, the direction indicator lamp 10 is essentially comprised of an adapter 101, a housing 102 and a tungsten bulb. Wherein, a bulb sleeve 104 is provided in the adapter 101, and a power cable 105 adapted with a power switch is connected to the battery of the vehicle for power supply. The design of the structural form of the bulb sleeve 104 in the adapter 101 compromises that of a holder 1030 of the tungsten bulb 103. Even though the design may vary among manufacturers, fast removal and mounting as well as secured fixation generally govern the design. When the tungsten bulb 103 is fixed with its holder 1030 in the bulb sleeve 104 of the adapter 101; the adapter is incorporated to the housing 102 to complete the assembly of the direction indicator lamp 10 and the assembly is then mounted to the rear of the vehicle. The driver by operating the switch turns on the tungsten bulb 103 to achieve indication and warning purposes.

Whereas the indicator lamp 10 has been used to a vehicle for quite a long time, many motor manufacturers and consumers have gradually found out that the indicator lamp 10 does not necessarily fall within the range of the optimal vision for being limited to the style of the body of the vehicle. Accordingly, the indicator lamp 10 cannot be easily seen by people in other vehicles or pedestrians. Usually, the vehicle is moving, and the visual range changes constantly to result in many blind angles to discount the indication and warning functions of the indicator lamp 10.

To correct this, many drivers choose to add certain warning devices to other locations on the body of the vehicle. A reflection sticker A as illustrated in FIG. 4 is adhered to a helmet in case of a motorcycle rider as illustrated in FIG. 5 or on the clothing as illustrated in FIG. 6 to further improve the attention upon reflecting the light emitted from other vehicle. However, the result of the reflection sticker A is very limited since it is not a light-emitting source. Its performance is determined by the luminance of the external light source and its respective range with that light source. Therefore, the reflection sticker is considered as a passive and uncertain type of application.

### SUMMARY OF THE INVENTION

The primary purpose of the present invention is to provide an LED indicator set adapted with a radio signal transmitter so that when the LED indicator set is conducted, the light is emitted and the radio signal is transmitted.

Another purpose of the present invention is to provide an LED indicator set adapted with a radio signal transmitter to transmit signals to an external warning indicator to light up the LED bulb in the external warning indicator for achieving warning results.

The foregoing object and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a schematic view showing an indicator of the prior art is adapted to a motor vehicle.

FIG. 2 is another schematic view showing an indicator of the prior art is adapted to a motor vehicle.

FIG. 3 is a sectional view of a direction indicator lamp of the prior art.

FIG. 4 is a schematic view showing a reflection sticker of the prior art is adhered to a body of a vehicle.

FIG. 5 is a schematic view showing a reflection sticker of the prior art is adhered to a helmet of a motorcycle rider.

FIG. 6 is a schematic view showing a reflection sticker of the prior art is adhered to the clothing of a motorcycle rider.

FIG. 7 is an exploded view of a preferred embodiment of the present invention.

FIG. 8 is a sectional view of the preferred embodiment of the present invention.

FIG. 9 is an exploded view of an external indicator lamp.

FIG. 10 is a schematic view showing an application of the preferred embodiment of the present invention.

FIG. 11 is a schematic view showing another preferred embodiment of the present invention.

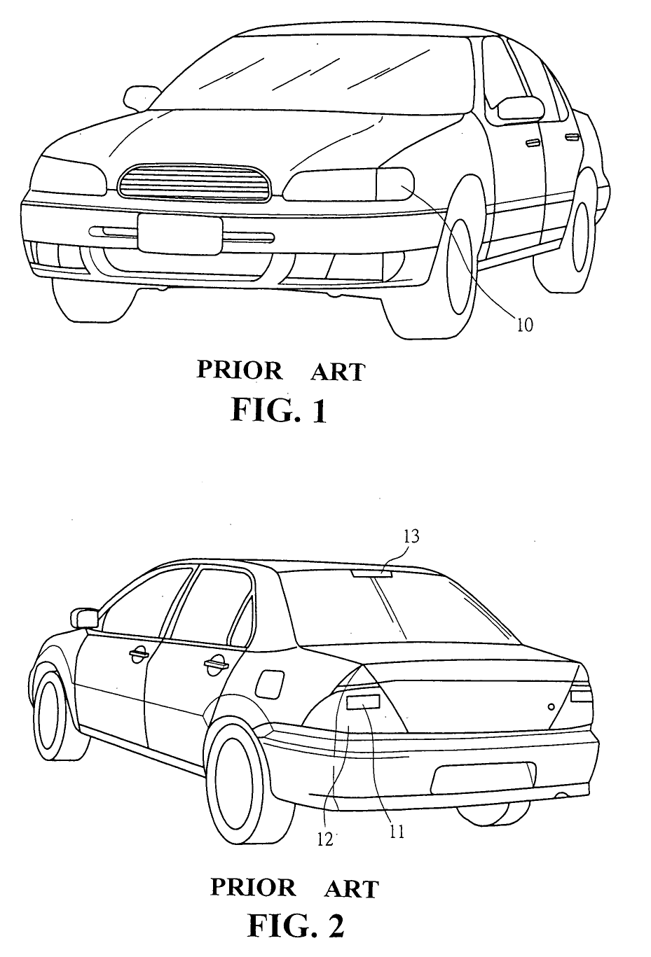

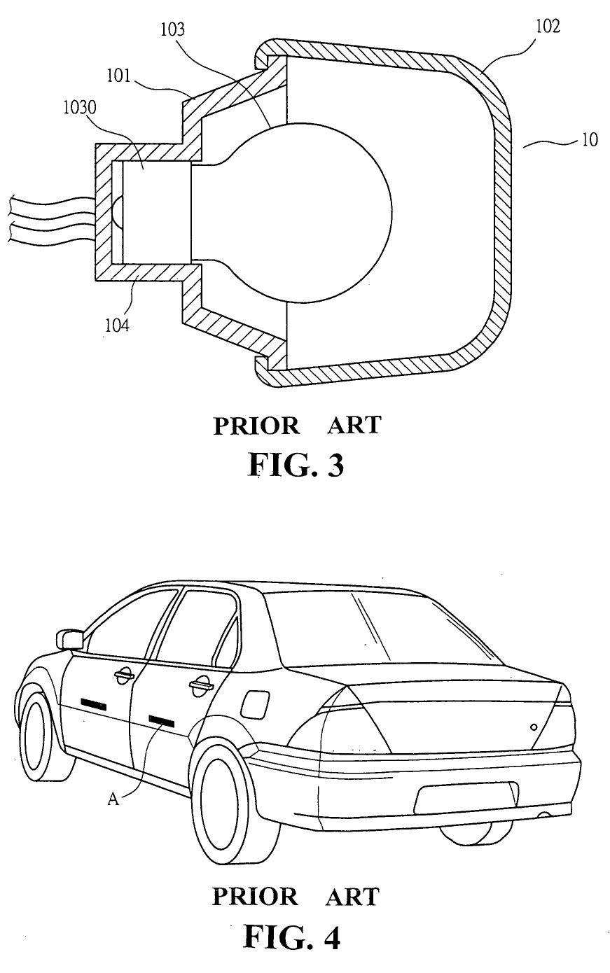

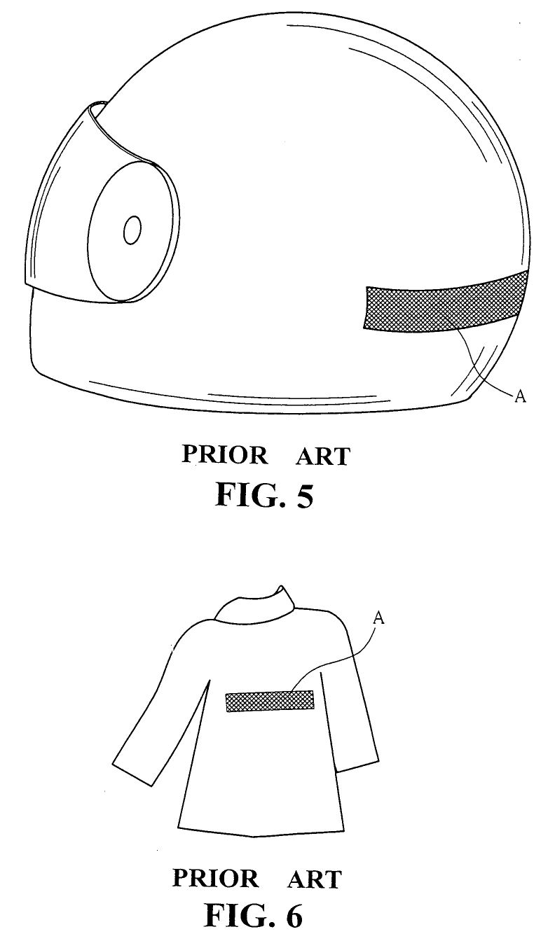

### DETAILED DESCRIPTION OF THE PREFERRED EMBODIMENTS

The following descriptions are of exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

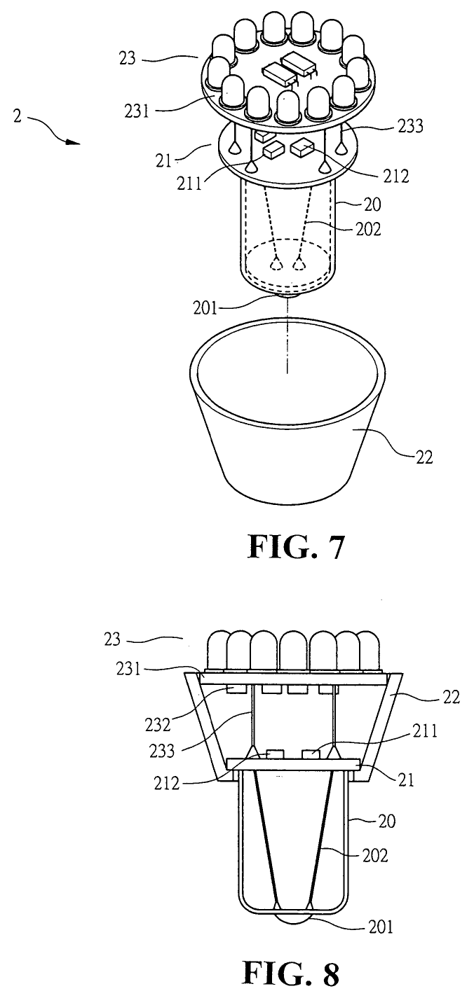

The present invention is related to an LED indicator set adapted with a radio signal transmitter. Referring to FIG. 7, the LED indicator set 2 includes an adapter 20, a radio signal transmitter 21, a protection cap 22 and an LED indicator group 23 comprised of multiple light emitting diodes. As illustrated in FIG. 8, the adapter 20 is provided with a contact 201 connected to a radio signal transmitter 21 through a conductor 202. The radio signal transmitter is provided with an electronic circuit set 211 for the transmission of signals, and an antenna 212 for the transmission. The LED indicator set 23 is fixed to a motherboard 231, and another electronic circuit set 232 to be applied by the LED indicator group 23 is provided to the motherboard 231. A conductor 233 connects both electronic circuit sets 211, 232 respectively from the radio signal transmitter 21 and the motherboard 231 even if the LED indicator group 23 and the radio transmitter 21 are connected in series. Both of the LED indicator group 23 and the radio signal transmitter 21 are covered by the protection cap 22. Once the power is supplied, the LED indicator group 23 is emitting light and the radio signal transmitter 21 transmits the preset signals.

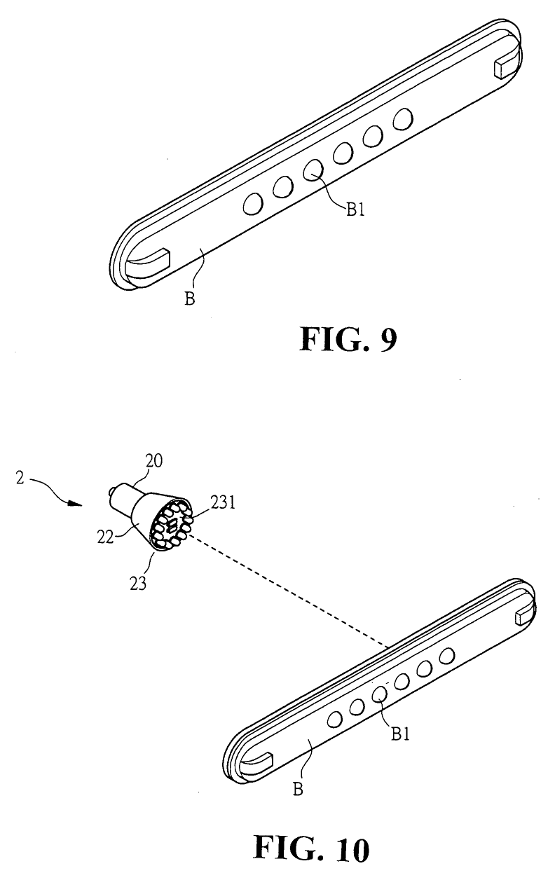

Now referring to FIG. 9, the present invention is applied to a general vehicle (in the form of a braking lamp, a direction indicator lamp and a reversing indicator lamp). Wherein, the user may forthwith remove the tungsten bulb and replace it with the LED indicator set 2 of the present invention. An external warning indicator set B comprised of multiple LED indicators B1, a radio signal receiver and a switch is further provided in relation to the radio signal transmitter in the LED indicator set 2. The outer side is attached with an adhesive element such as a magnet or a double-faced adhesive tape.

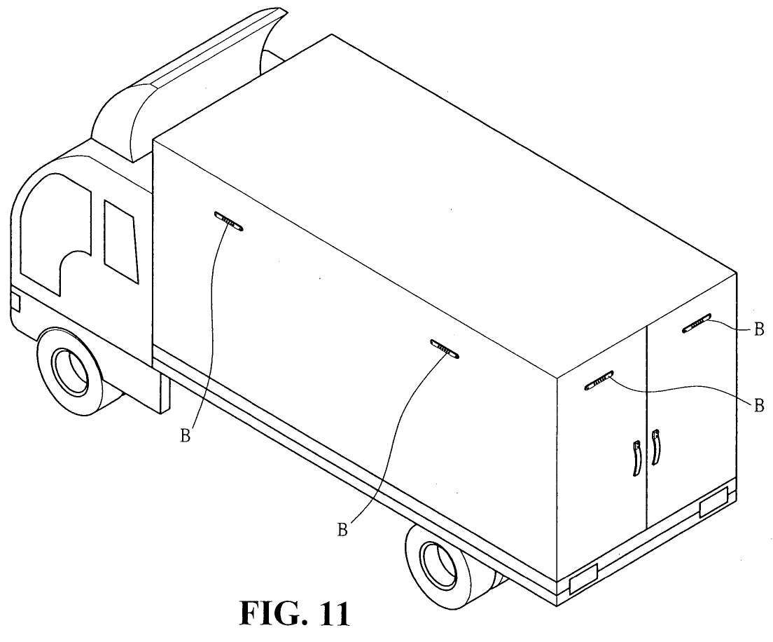

In practice as illustrated in FIG. 10, the adapter 20 of the LED indicator set 2 of the present invention is fixed to the bulb protection cap of the vehicle, and the switch at the external warning indicator set B is turned on to enter into standby status for receiving signals and light emission. The LED indicator set 2 procures the power and control through the power cable and the switch in the protection cap 22. When the direction indicator, the braking indicator or the reversing indicator lamp is activated through the system designed for the vehicle, the LED indicator group 23 in the LED indicator set 2 is lighted to execute its indication function. Meanwhile the radio signal transmitter in the LED indicator set 2 transmits its signals at the same time. Upon picking up the radio signals by the receiver in the external warning indicator set B, those multiple LED indicators B1 of the external warning indicator set B are activated for light emission to provide further warning function. Furthermore, when the present invention is applied to a motorcycle, the external warning indicator set B is fixed to the helmet or the back of the rider to highlight visual exposure. If the present invention is applied in a heavy-duty vehicle such as a bus, truck, truck tractor, or a tandem tractor trailer, the external warning indicator set B may be fixed to both sides or the upper rear of the body as illustrated in FIG. 11 to serve further warning purpose. When applied in a semi-trailer, the external warning set B may be stick to the body at where as desired by means of a magnet. Upon completing the unloading, the external warning set B is removed for the next application to achieve convenient and economic benefits.

The light color of the LED indicator group 23 in the LED indicator set 2 of the present invention may be selected as desired and may be connected in parallel to make sure that in the event that the failure of certain LED indicators will not affect the light emission by the remaining LED indicators.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. An LED indicator set adapted with a radio signal transmitter including a lamp adapter containing a contact to conduct to an external source and a conductor to connect through the radio signal transmitter; the radio signal transmitter containing electronic circuit set and an antenna; an LED indicator set fixed to a motherboard provided with the electronic circuit set for the application by the LED indicator set and connected in series with the radio signal transmitter; the contact of the lamp adapter receiving the power from external source and supplying the power to the radio signal transmitter and the LED indicator set; and the LED set emitting the light in synchronous with the transmission of the signals from the radio signal transmitter.

2. The LED indicator set adapted with a radio signal transmitter of claim 1, wherein, an external warning indicator set is further adapted to the LED indicator set.

3. The LED indicator set adapted with a radio signal transmitter of claim 1, wherein, the LED indicator set is connected in parallel with the radio signal transmitter.
